(19) United States
(12) Patent Application Publication
(10) Pub. No.: US 2025/0161927 A1
(43) Pub. Date: May 22, 2025

(54) A CATALYST COMPOSITION

(71) Applicant: NATIONAL UNIVERSITY OF SINGAPORE

(72) Inventors: Kok Giap Haw, Singapore (SG); Kang Hui Lim, Singapore (SG)

(21) Appl. No.: 18/834,955

(22) PCT Filed: Jan. 31, 2023
(86) PCT No.: PCT/SG2023/050054

§ 371 Date: Jul. 31, 2024

(30) Foreign Application Priority Data
Jan. 31, 2022 (SG) 10202200972X

(51) Int. Cl. B01J 37/02; B01J 21/12; B01J 31/18; B01J 31/22; B01J 35/45; B01J 37/04; B01J 37/08; C01B 3/40

(52) U.S. Cl. CPC B01J 37/0205; B01J 21/12; B01J 31/1805; B01J 31/2243; B01J 35/45; B01J 37/0203; B01J 37/0236; B01J 37/04; B01J 37/088; C01B 3/40; B01J 2531/004; B01J 2531/0216; B01J 2531/0241; B01J 2531/38; B01J 2531/847; C01B 2203/0233; C01B 2203/1058; C01B 2203/1241

(57) ABSTRACT

The present disclosure relates to a catalyst composition comprising a first metal complex and optionally a second metal complex dispersed throughout a matrix of an inorganic material. The present disclosure also relates to a method for preparing the catalyst composition, a catalyst comprising the catalyst composition, use of the catalyst composition as a catalyst or the catalyst for converting natural gas to syngas and a method for converting natural gas to syngas using the catalyst composition as a catalyst or the catalyst.

### CROSS-REFERENCE TO RELATED APPLICATIONS

This application claims priority to Singapore Application No. 10202200972X filed with the Intellectual Property Office of Singapore on 31 Jan. 2022, the contents of which is hereby incorporated by reference in its entirety for all purposes.

### FIELD OF THE INVENTION

The present disclosure relates generally to the field of chemical catalysts. The present disclosure relates generally to a catalyst composition, a method of preparing the catalyst composition, a catalyst comprising the catalyst composition supported on a support material and use of the catalyst or catalyst composition, such as in steam methane reforming.

### BACKGROUND OF THE INVENTION

Natural gas, while touted to be one of the cleanest fuels, is not completely carbon free. Steam Methane Reforming (SMR) is the dominant process for the production of hydrogen and syngas (i.e., raw material for methanol and valuable chemicals production) from natural gas. Presently, over 95% of hydrogen production in the United States and over 48% globally, is produced via SMR. While SMR is the preferred choice for hydrogen production, the caveat is that for every kg of hydrogen produced, 7 kg of carbon dioxide is produced, hence the produced hydrogen is known as ‘grey hydrogen’, and accounts for 3% of global industrial sector CO₂ emissions. Further, current industrial catalysts for SMR are prone to deactivation by coking if there is an insufficient steam input to gasify the carbon deposit. That is, SMR catalysts are prone to carbon deposition from deep hydrocarbon cracking/dehydrogenation which in turn requires more steam input (i.e., higher steam to carbon; S/C ratio) to mitigate coke formation. Moreover, the highly endothermic nature of the SMR reaction requires significantly high operating temperatures for efficient production of hydrogen.

There is therefore a need for a catalyst that at least partially ameliorates the disadvantages above.

### SUMMARY OF THE INVENTION

In an aspect, there is provided a catalyst composition comprising a first metal complex and optionally a second metal complex dispersed throughout a matrix of an inorganic material.

Advantageously, the first metal complex and second metal complex, when present, may be dispersed throughout the matrix of the inorganic material in such a way as to minimize agglomeration of the first metal complex and second metal complex, when present, during calcination and reduction conditions, thereby achieving high dispersion of the first metal complex and second metal complex, when present, throughout the inorganic material. This may facilitate high hydrocarbon or methane conversion when the catalyst composition is used as a catalyst in a steam methane reforming (SMR) reaction even at a lower operating temperature.

More advantageously, the catalyst composition of the present application may be used under a wide range of operating conditions while maintaining high stability, activity and efficiency. The catalyst composition of the present application may operate at a significantly lower operating temperature of below 800° C. in comparison to conventional. commercially available catalysts that operate at a higher temperature of between 800° C. to 950° C., while maintaining high catalyst stability and low coking, even when used at a significantly low Steam/Carbon ratio of 0.3. As heating at a higher temperature may result in significantly higher energy consumption and is coupled with a high carbon footprint if non-renewable energy sources are used, the catalyst composition as defined above may circumvent such issues. Moreover, the versatility of the catalyst composition allows for its use in SMR processes at different temperatures and S/C ratios.

Further advantageously, the components of the catalyst composition as defined above may be easier to store and transport, and may be used after drying or impregnation into a support material, making the preparation of the catalyst composition very versatile.

In another aspect, there is provided a method for preparing a catalyst composition comprising a first metal complex, and optionally a second metal complex, dispersed throughout a matrix of an inorganic material, comprising the steps of:
(a) providing a solution of the first metal complex and optionally a solution of the second metal complex;
(b) providing a solution of the inorganic material; and
(c) mixing the solution of the first metal complex and optionally the solution of the second metal complex with the solution of the inorganic material, to form a dispersion of the first metal complex, and optionally the second metal complex, throughout the matrix of the inorganic material and thereby the catalyst composition.

In another aspect, there is also provided a catalyst comprising a catalyst composition comprising a first metal complex, and optionally a second metal complex. dispersed throughout a matrix of an inorganic material.

In another aspect, there is also provided a catalyst comprising a catalyst composition comprising a first metal complex, and optionally a second metal complex, dispersed throughout a matrix of an inorganic material embedded in a support material.

Further advantageously, the catalyst composition as defined above may not rely on the structure or form of a support material for catalytic activity. The catalyst composition may therefore be impregnated, coated or mixed with a variety of support materials which may be customizable (i.e. have different structures and forms) depending on its use, making the catalyst composition versatile. Advantageously, this may mean that even if a support material is used and is excessively impregnated with the catalyst composition, metal agglomeration or negative reaction outcomes such as carbon formation may not be observed.

In another aspect, there is provided the use of the catalyst composition as defined herein as a catalyst, or the catalyst as defined herein for converting natural gas to syngas.

Advantageously, the catalyst composition as defined above may be able to catalyze steam methane reforming (SMR) reactions of natural gas (mainly hydrocarbons such as methane) in a more energy-efficient (i.e., lower operating cost per yield) and economical (i.e., lesser steam requirements) manner with a lower CO₂ emission, which is an outcome only possible if the reaction is performed at low temperature and low Steam/Carbon (S/C) ratio. The low S/C ratio contributes to energy savings as less energy is required for sustained heating when there is less overall feed mass. By using a metal complex dispersed throughout a matrix of an inorganic material which is further tunable by using different support materials to support the catalyst, the catalyst composition as defined above may advantageously provide significant cost and energy savings resulting from higher H2 yield and CH4 conversion rate with strong robustness against coking and carbon formation which in turn allows for SMR reactions to be performed at low reaction temperature and low Steam/Carbon ratio for a greener process of H2 production (i.e., low CO₂ emission per kg of H2 production).

Advantageously, the catalyst composition as defined above may offer high resistance to metal sintering and carbon formation, therefore avoiding excessive coking that may decrease the efficiency of the SMR reactions. Further advantageously, the catalyst composition as defined above may achieve carbon neutrality or even carbon negativity due to the consumption of CO₂ along with steam and methane (i.e., bi-reforming of methane) during the SMR reaction.

In another aspect, there is provided a method for converting natural gas to syngas, the method comprising the step of contacting the catalyst composition as defined herein as a catalyst or the catalyst as defined herein with natural gas.

### Definitions

The term “dispersed throughout” as used herein refers to the state in which the metal complex is distributed or spread over a substantial portion of the inorganic material, with strong electrostatic interaction present between the positive charges of the metal complex and the negative charges of the inorganic material.

“Alkyl” as a group or part of a group refers to a straight or branched aliphatic hydrocarbon group, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

“Alkenyl” as a group or part of a group denotes an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

“Alkynyl” as a group or part of a group means an aliphatic hydrocarbon group containing a carbon-carbon triple bond and which may be straight or branched preferably having from 2-12 carbon atoms, more preferably 2-10 carbon atoms, more preferably 2-6 carbon atoms in the normal chain. Exemplary structures include, but are not limited to, ethynyl and propynyl. The group may be a terminal group or a bridging group.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

As used in this application, the singular form “a,” “an,” and “the” include plural references unless the context clearly dictates otherwise. For example, the term “a genetic marker” includes a plurality of genetic markers, including mixtures and combinations thereof.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### DETAILED DESCRIPTION OF OPTIONAL EMBODIMENTS

Exemplary, non-limiting embodiments of a catalyst composition will now be disclosed. There is provided a catalyst composition comprising a first metal complex, and optionally a second metal complex, dispersed throughout a matrix of an inorganic material.

There is provided a catalyst composition comprising a first metal complex and a second metal complex dispersed throughout a matrix of an inorganic material.

There is provided a catalyst composition comprising a metal complex dispersed throughout a matrix of an inorganic material.

The first metal complex and the second metal complex may be the same or different. The catalyst composition comprises a plurality of the first metal complex and a plurality of the second metal complex, when present.

The first metal complex and the second metal complex (when present) may be mixed in a ratio in the range of about 1:0.01 to about 1:1.00 by weight.

The metal complex may comprise a catalyst metal and a ligand. The term “catalyst metal” is used to denote the metal used in the metal complex as opposed to the metal used in the inorganic material (“matrix metal”) and in the support material (“support metal”) defined further below. Hereinafter, the term “metal complex” is used generally (unless specified otherwise) to refer to the first metal complex only (when the second metal complex is absent) and collectively to the first and second metal complexes (when the second metal complex is present). The same interpretation applies to the catalyst metal and the ligand.

The catalyst metal may catalyse a steam methane reforming (SMR) reaction or a reaction to convert natural gas to syngas.

The catalyst metal may be an alkaline earth metal, a transition metal, a lanthanoid metal or a mixture thereof.

The alkaline earth metal may be selected from the group consisting of Be, Ca, Mg, Sr, Ba and Ra or a mixture thereof, occupying Group 2 of the periodic table.

The transition metal may be selected from the group consisting of group 4 transition metal, group 6 transition metal, group 8 transition metal, group 9 transition metal, group 10 transition metal, group 11 transition metal, group 12 transition metal and any mixture thereof.

The lanthanoid metal may be selected from the group consisting of La, Ce, Yb, Eu, Dy, Tb, Pm, Pr, Sm, Nd, Lu, Gd, Ho, Tm, Er and Y or a mixture thereof.

The catalyst metal may be selected from the group consisting of Ca, Mg, La, Ni, Pt, Co, Mo, Zr, Sr, Ce, Fe, Zn and any mixture thereof

The ligand may comprise a coordinating group selected from the group consisting of an amino, hydroxyl, carboxylate, and any mixture thereof.

The amino group may be ammonia, primary amine, secondary amine or a tertiary amine.

The ligand may further comprise an aliphatic group linking two or more coordinating groups.

The aliphatic group may be selected from the group consisting of alkyl, alkenyl, alkynyl and any mixture thereof.

The aliphatic group may have a carbon chain length in the range of C₁ to C₁₂.

The ligand may be selected from the group consisting of ammonia, ethylamine, diethylamine, triethylamine, pyrrolidine, pyrrole, imidazolidine, pyrazolidine, imidazole, pyrazole, oxazolidine, isoxazolidine, oxazole, isoxazole, triazole, furazan, oxadiazole, dioxazole, tretrazole, piperidine, pyridine, diazinane, diazine, morpholine, oxazine, ethylene diamine (en), ethylene triamine, ethylenediaminetetraacetic acid (EDTA), ethyleneglycoltetraacetic acid, ethylendiaminedipropionic acid, hexamethylenediaminetetraacetic acid, dipicolinic acid, diethylenetriaminepentaacetic acid, nitrilotriacetic acid in their ionic or neutral form and any mixture thereof.

The first metal complex may be [Ni(en)₃] (NO₃)₂ and the second metal complex may be [Ce(EDTA)] (NO₃)₃.

The inorganic material may be negatively charged, or may have a negative surface charge.

The inorganic material may be amorphous, partially amorphous or crystalline.

The inorganic material may comprise silicon, a silicon-containing compound, a metallosilicate, a heterometallosilicate, a metal oxide or a combination thereof as the main component.

The silicon-containing compound may be silica or silica-alumina.

The silicon or silicon-containing compound may further comprise a matrix metal or a matrix semi-metal.

The metallosilicate or the heterometallosilicate may comprise a matrix metal or a matrix semi-metal that forms an oxide bond with silica. Thus, the metallosilicate or the heterometallosilicate may comprise a silicate of the matrix metal or matrix semi-metal. The metallosilicate may be titanium-silicate.

The matrix metal or matrix semi-metal may be selected from the group consisting of Al, As, B, Be, Cr, In, Ti, Zr, Fe, Co, V, Ga, Ge, Sb, Sn, Mo, Mg, W and any mixture thereof.

The metal oxide may be an oxide of a metal or a semi-metal selected from the group consisting of Al, As, B, Be, Ca, Ce, Cr, In, Ti, Zr, Fe, Co, V, Ga, Ge, Sb, Si, Sn, Mo, Mg. W and any mixture thereof.

The inorganic material may comprise silica and alumina. The Si/Al molar ratio may be about 1 to about 100,000, about 10 to about 100,000, about 30 to about 100,000, about 50 to about 100,000 and about 100 to about 100,000.

The inorganic material forms a matrix whereby the main component (which as defined above, is silicon, silicon-containing compound, metallosilicate, heterometallosilicate, metal oxide or combination thereof) is interconnected such as via polymerization by covalent bond between the main component or through electrostatic interaction between the main component to form a framework. As an example, when the inorganic material is silica, each silicon atom is bonded to four oxygen which are arranged tetrahedrally around it and each oxygen atom is attached to two other silicon atoms by covalent bonds repeatedly to form an interconnected matrix.

The inorganic material may have a strong interaction with the metal complex.

The metal complex may be dispersed throughout the matrix of the inorganic material.

The inorganic material may have different morphology and surface properties to provide strong interaction between the metal complex and the matrix of the inorganic material. Due to the amorphous morphology of the inorganic material, the functional groups present on the surface of the inorganic material is able to form strong interaction with the metal complex during high temperature calcination.

The functional group present on the surface of the inorganic material may be selected from the group consisting of silanol groups, silicate groups, hydroxy groups and any mixtures thereof.

The interaction may be an electrostatic interaction between the positive charge of the metal complex and the negative charge of the inorganic material. The negative charge of the inorganic material may facilitate stabilization of the positive charge of the metal complex.

The metal complex may be immobilized in the matrix of the inorganic material due to the electrostatic interaction.

The inorganic material may encapsulate each metal complex in the matrix.

The inorganic material may form a barrier between each metal complex in the matrix.

The inorganic material may form a layer between each metal complex in the matrix to separate the metal complexes from one another and to prevent agglomeration of the metal complex.

Due to the presence of the inorganic material, the agglomeration of the catalyst metal in the metal complex may be prevented during calcination and reduction conditions.

The inorganic material may be chemically inert with respect to the catalytic reaction performed by the catalyst metal in the metal complex.

The metal complex may be dispersed substantially homogeneously throughout the matrix of the inorganic material.

The ratio of the first metal complex and second metal complex, when present, and the inorganic material in the matrix may be in the range of about 1:1 to about 1:80 by weight.

The catalyst composition may be amorphous.

The catalyst composition may be in the form of particles.

The catalyst composition in the form of particles may have a diameter in the range of about 1 nm to about 20 nm, about 1 nm to about 15 nm, about 1 nm to about 10 nm, about 1 nm to about 5 nm, preferably about 4 nm to about 6 nm.

The inorganic material may have a strong interaction with the metal complex so as to maintain a small particle size of the catalyst composition, when in particulate form.

The particle size (such as the diameter) may change depending on the concentration of the metal complex in the matrix. When the concentration of the metal complex is low, the particle size may be smaller, whereas if the concentration of the metal complex is high, the particle size may be larger. With increasing concentration, more inorganic material may be incorporated into the particle to counterbalance the surface charge of the metal complex, resulting in an increase in particle size. The particle size of the catalyst composition may be in the range of about 1 nm to about 2 nm when the concentration of the metal complex is about 1 wt % based on the total weight of the solution after mixing with the solution of the inorganic material. The particle size of the catalyst composition may be in the range of about 2 nm to about 3 nm when the concentration of the metal complex is about 3 wt % based on the total weight of the solution after mixing with the solution of the inorganic material. The particle size of the catalyst composition may be in the range of about 3 nm to about 4 nm when the concentration of the metal complex is about 5 wt % based on the total weight of the solution after mixing with the solution of the inorganic material. The particle size of the catalyst composition may be in the range of about 4 nm to about 5 nm when the concentration of the metal complex is about 13 wt % based on the total weight of the solution after mixing with the solution of the inorganic material. The particle size of the catalyst composition may be in the range of about 5 nm to about 7 nm when the concentration of the metal complex is about 26 wt % based on the total weight of the solution after mixing with the solution of the inorganic material.

The particles may be stable and may not form a precipitate in solution. A solution of the catalyst composition particles may be shelf-stable for several months if stored in a cool dark place such as a refrigerator.

The small particle size of the catalyst composition in the range of about 1 nm to about 7 nm, about 2 nm to about 7 nm, about 3 nm to about 7 nm, about 4 nm to about 7 nm, about 5 nm to about 7 nm and about 6 nm to about 7 nm, may prevent coke deposition. The catalyst composition may be impregnated in a support material.

The catalyst composition may be used on its own after drying, or a support material may be used as a diluent to provide mechanical strength to the catalyst composition.

The support material may be porous.

The pore size of the support material may be in the range of about 2 nm to about 50 nm, about 2 nm to about 50 nm, about 2 nm to about 50 nm, about 2 nm to about 50 nm, about 2 nm to about 50 nm and about 2 nm to about 50 nm when the support material is mesoporous.

The pore size of the support material may be in the range of about 50 nm to about 5000 nm, about 100 nm to about 5000 nm, about 1000 nm to about 5000 nm, about 2000 nm to about 5000 nm, about 3000 nm to about 5000 nm, about 4000 nm to about 5000 nm, when the support material is macroporous.

The support material may be selected from the group consisting of silica, alumina, silica-alumina, aluminosilicate mineral, aluminium silicate, titanium silicate, clay, halloysite clay, metal alloy, montmorillonite clay, zeolite, porous glass, support metal oxide, support semi-metal oxide, molecular sieve, silica gel and any mixture thereof.

The metal alloy may be selected from the group consisting of incoloy, inconel, brass, bronze, pewter, stainless steel or mixtures thereof.

The support metal oxide may be an oxide of a support metal or a support semi-metal selected from the group consisting of Al, As, B, Be, Ca, Ce, Cr, In, Ti, Zr, Fe, Co, V.

Ga, Ge, Sb, Si, Sn, Mo, Mg. W and any mixture thereof.

The support material may be a powder, extrudate, tablet, granule, pellet, ring, foil, sphere, foam, membrane, minilith, monolith, honeycomb, flat surface, cylinder, tube or any combination thereof.

The cylinder may have a hollow, cylcut, muti-hole, daisy or trilobe shape.

The support material may have a shape and size that may minimize pressure drop when used in a reactor. The support material may be a multi-hole cylindrical pellet or may have a Raschig Rings design to facilitate greater mass transport.

The support material may have a diameter in the range of about 10 mm to about 20 mm, about 12 mm to about 20 mm, about 14 mm to about 20 mm, about 16 mm to about 20 mm and about 18 mm to about 20 mm, to enhance mass transfer and minimize pressure drop.

The support material may have multi-hole design with vertical grooves wherein the holes are in the range of about 4 holes to about 7 holes, about 5 holes to about 7 holes and about 6 holes to about 7 holes, to enhance mass transfer and minimize pressure drop.

When the inorganic material comprises silica, the amorphous nature of the silica may result in a large number of silanol groups to be present on the surface of the inorganic material. These silanol groups may strongly interact with the support material, when the support material is silica-alumina, zeolites, support metal oxides, support semi-metal oxides.

The support material may be impregnated with the catalyst composition at a ratio in the range of about 2:1 to about 1:15 by weight.

The catalyst composition may be calcined.

The support material impregnated with the catalyst composition may be calcined.

The catalyst composition or the support material impregnated with the catalyst composition may be calcined at a temperature in the range of about 550° C. to about 1200° C., about 650° C. to about 1200° C., about 750° C. to about 1200° C., about 850° C. to about 1200° C., about 950° C. to about 1200° C., or about 1050° C. to about 1200° C.

The calcined catalyst composition may not comprise any NiO bonds.

There is also provided a method for preparing a catalyst composition comprising

a first metal complex, and optionally a second metal complex, dispersed throughout a matrix of an inorganic material, comprising the steps of:
(a) providing a solution of the first metal complex and optionally a solution of the second metal complex;
(b) providing a solution of the inorganic material; and
(c) mixing the solution of the first metal complex and optionally the solution of the second metal complex with the solution of the inorganic material, to form a dispersion of the first metal complex and optionally the second metal complex throughout the matrix of the inorganic material and thereby the catalyst composition.

The providing step (a) may comprise the step of mixing a catalyst metal salt with a ligand in a first solvent to form the metal complex.

The providing step (a) may comprise the step of mixing a first catalyst metal salt with a first ligand in a first solvent to form the first metal complex, wherein the first catalyst metal salt may comprise a first catalyst metal cation of a first catalyst metal and a first counteranion, and where the second metal complex is present, the providing step (a) also includes the step of mixing a second catalyst metal salt with a second ligand in a second solvent to form the second metal complex, wherein the second catalyst metal salt may comprise a second catalyst metal cation of a second catalyst metal and a second counteranion.

The first counteranion and second counteranion, when present, may independently be selected from the group consisting of halide, nitrate, sulfate, hydroxide, carbonate, phosphate and any mixture thereof.

The first catalyst metal and the first ligand may be mixed at a ratio in the range of 1:2 to 1:7 by weight. When present, the second catalyst metal and the second ligand, when present, may be mixed at a ratio in the range of 1:2 to 1:7 by weight.

The providing step (b) may comprise the step of mixing an inorganic material precursor with a third solvent.

The inorganic material precursor may be selected from the group consisting of silane, orthosilicate, tetramethyl orthosilicate, tetraethyl orthosilicate, aluminium chloride, aluminium nitrate, aluminium sulphate, tetrabutylortho titane, tetraethyl titane, tetrapropylortho titane, Na₂HAsO₄·7H₂O, H₃BO₃, BeSO₄·4H₂O, Cr(NO₃)₃·9H₂O, In(NO₃)₃·xH₂O, Ti[OCH(CH₃)₂]₄·Zr(NO₃)₄·Fc(NO₃)₃·9H₂O, Co(NO₃)₂·6H₂O, NaVO₃, Ga(NO₃)₃·xH₂O, Ge(OCH(CH₃)₂)₄, KSb(OH)₆, Na₂SnO₃·3H₂O, Na₂MoO₄, Mg(NO₃)₂·6H₂O, Na₂WO₄·2H₂O and any mixture thereof.

The providing step (b) may further comprise the step of hydrolyzing the inorganic material precursor with a base. The base may be selected from the group consisting of tetrapropylammonium hydroxide, tetramethylammonium hydroxide, tctracthylammonium hydroxide, tetrabutylammonium hydroxide, hexapropyl-1,6-hexanediammonium, N,N,N-trimethyl-1-adamantanammonium hydroxide, and any mixture thereof.

The matrix of the inorganic material may be formed by hydrolysis of the inorganic material precursor by the base.

The base may additionally function as a template and porogen to form micropores in the matrix of the inorganic material.

The providing step (b) may thus comprise the steps of (b1) mixing an inorganic material precursor with the third solvent, wherein the inorganic material precursor is selected from the group consisting of silane, orthosilicate, tetramethyl orthosilicate, tetraethyl orthosilicate, aluminium chloride, aluminium nitrate, aluminium sulphate, tetrabutylortho titane, tetraethyl titane, tetrapropylortho titane, Na₂HAsO₄·7H₂O, H₃BO₃, BeSO₄·4H₂O, Cr(NO₃)₃·9H₂O, In(NO₃)₃·xH₂O, Ti[OCH(CH₃)₂]₄, Zr(NO₃)₄, Fc(NO₃)₃·9H₂O, Co(NO₃)₂·6H₂O, NaVO₃, Ga(NO₃)₃·xH₂O, Ge(OCH(CH₃)₂)₄, KSb(OH)₆. Na₂SnO₃·3H₂O, Na₂MoO₄, Mg(NO₃)₂·6H₂O, Na₂WO₄·2H₂O and any mixture thereof; and (b2) hydrolyzing the inorganic material precursor with the base, wherein the base is selected from the group consisting of tetrapropylammonium hydroxide, tetramethylammonium hydroxide, tetraethylammonium hydroxide, tetrabutylammonium hydroxide, hexapropyl-1,6-hexanediammonium, N,N,N-trimethyl-1-adamantanammonium hydroxide, and any mixture thereof.

The first solvent, second solvent (when present) and third solvent may independently be water or an aqueous solution.

The water may be distilled water.

The mixing step (c) may be performed at room temperature at ambient pressure for a duration in the range of about 15 minutes to about 2 hours, about 30 minutes to about 2 hours, about 45 minutes to about 2 hours, about 1 hour to about 2 hours, about 1 hour 15 minutes to about 2 hours, about 1 hour 30 minutes to about 2 hours, or about 1 hour 45 minutes to about 2 hours.

The room temperature may be selected from a range of about 20° C. to about 30° C., about 23° C. to about 30° C., about 25° C. to about 30° C., or about 27° C. to about 30° C.

The ambient pressure may be selected from a range of about 90 kPa to about 110 kPa, about 95 kPa to about 110 kPa, about 100 kPa to about 110 kPa, or about 105 kPa to about 110 kPa.

The mixing step (c) may be performed at an alkaline pH, or at a pH in the range of about 8 to about 14, about 9 to about 14, about 10 to about 14, about 11 to about 14, about 12 to about 14, or about 13 to about 14.

The mixing step (c) may be undertaken at at least one of: (i) a temperature in the range of 20° C. to 30° C.; (ii) an ambient pressure in the range of 90 kPa to 110 kPa; (iii) a duration in the range of 15 minutes to 2 hours; (iv) a pH in the range of 8 to 14; or (v) all of (i) to (iv).

The metal complex and inorganic material precursor in the mixing step (c) may be mixed wherein the solution of the first metal complex and solution of the second metal complex, when present, to the solution of the inorganic material may be present at a ratio in the range of 1:5 to 1:260 by weight.

The method may further comprise the step (d) of impregnating a support material with the catalyst composition after mixing step (c) by mixing the catalyst composition with the support material, or contacting a solution of the catalyst composition with the support material. When the catalyst composition is mixed with the support material, the support material may be in solid form.

The support material may be prepared by 3D printing.

To modify the viscosity of the support material, the support material may comprise an additive selected from the group consisting of hydroxypropyl methyl cellulose, sodium silicate, methylcellulose, hydroxypropyl cellulose, hydroxyethyl cellulose, carboxymethyl cellulose, hydroxyethyl methylcellulose and any mixture thereof, so that the support material may be prepared by 3D printing.

The support material may be pre-treated with heat at a temperature in the range of about 800° C. to about 1200° C., about 900° C. to about 1200° C., about 1000° C. to about 1200° C., about 1100° C. to about 1200° C., for a duration in the range of about 15 hours to about 25 hours, about 17 hours to about 25 hours, about 19 hours to about 25 hours, about 21 hours to about 25 hours, or about 23 hours to about 25 hours, before the impregnation step.

The method may further comprise the step (e) of drying the catalyst composition after the mixing step (c) or the impregnated support material after the impregnating step

(d).

The method may further comprise the step (f) of calcining the catalyst composition after the mixing step (c), after the drying step (e) or the impregnated support material after the impregnating step (d).

Upon calcination and reduction, the catalyst metal may be immobilized by the inorganic material, thereby preventing the catalyst metal from agglomerating.

During calcination, the metal complex may decompose to the catalyst metal in its oxidized form and the ligand.

The oxidized catalyst metal may be reduced in-situ to its elemental form in a reactor before being used in catalysis.

Further upon calcination, the micropores formed by the use of the base during the hydrolysis of the inorganic material precursor may facilitate access to the catalyst metal during catalysis.

There is also provided a catalyst comprising a catalyst composition comprising a first metal complex, and optionally a second metal complex, dispersed throughout a matrix of an inorganic material.

There is also provided a catalyst comprising a catalyst composition comprising a first metal complex, and optionally a second metal complex, dispersed throughout a matrix of an inorganic material embedded in a support material.

There is also provided the use of the catalyst composition as defined above as a catalyst or the catalyst as defined above for converting natural gas to syngas.

When the catalyst as defined herein is used for SMR reaction, the resulting steam/carbon ratio (S/C ratio) may be in the range of about 0.3 to about 1, about 0.5 to about 1 or about 0.7 to about 1.

The use may comprise contacting the catalyst composition as defined above or catalyst as defined above with natural gas to produce syngas.

There is also provided a method for converting natural gas to syngas, the method comprising the step of contacting the catalyst composition as defined above as a catalyst or the catalyst as defined above with natural gas.

Natural gas may comprise methane, ethane, propane, carbon dioxide, nitrogen, hydrogen sulfide, helium or any mixture thereof.

Syngas may comprise hydrogen, carbon monoxide, carbon dioxide or any mixture thereof.

The catalyst composition or catalyst may be used at a temperature in the range of about 550° C. to about 1000° C., about 550° C. to about 800° C., about 650° C. to about 1000° C., about 750° C. to about 1000° C., about 850° C. to about 1000° C., or about 950° C. to about 1000° C.

### BRIEF DESCRIPTION OF THE DRAWINGS

The disclosure will be better understood with reference to the detailed description when considered in conjunction with the non-limiting examples and the accompanying drawings, in which:

FIG. 1 shows a schematic drawing of the silica-protected Ni, Ce complex structure used to prepare the novel Steam Methane Reforming (SMR) catalysts as disclosed herein.

FIG. 2 shows the X-ray diffraction (XRD) patterns for a commercial Nickel-based catalyst (C0) and the amorphous metal complex-inorganic material hybrid catalysts of the present disclosure (C₁ to C6).

FIG. 3 shows a schematic diagram showing a simulated steam methane reforming process with natural gas oxidation with air as the reactor heat source.

FIG. 4 comprises FIGS. 4a to 4f and shows the thermodynamic equilibrium results from a simulation of the catalytic process, varying both steam/carbon (S/C) ratio and reaction temperature simultaneously in a Gibbs reactor with steam methane reforming reaction and side reaction, water gas shift (WGS) reaction, where FIG. 4a shows for methane conversion, FIG. 4b shows for H₂ production, FIG. 4c shows for Total CO₂ production (combining both from WGS reaction and CO₂ produced from natural gas oxidation for heating in flue gas), FIG. 4d shows for CO₂ production from WGS reaction, FIG. 4e shows for total amount of CO₂ per kg of H₂ produced and FIG. 4f shows for energy efficiency (kg H₂ produced per kg of CH₄ used in natural gas heating).

FIG. 5 refers to a graph that shows the H₂-temperature programmed reduction (H₂-TPR) profile for a commercial Nickel-based catalyst (C0).

FIG. 6 comprises FIGS. 6a to 6f and refers to graphs that show the H₂-temperature programmed reduction (H₂-TPR) profile for the supported amorphous metal complex-inorganic material hybrid catalysts of the present disclosure, where FIG. 6a shows for clay-based Ni catalyst (C₁), where FIG. 6b shows for amorphous SiO₂—Al₂O₃based Ni catalyst (C2), where FIG. 6c shows for amorphous SiO₂—Al₂O₃ based Ni,Ce catalyst (C3), where FIG. 6d shows for amorphous SiO₂—Al₂O₃based Ni,Ce catalyst (C4), where FIG. 6e shows for amorphous SiO₂—Al₂O₃ based Ni,Ce catalyst (C5), and where FIG. 6f shows for amorphous SiO₂—Al₂O₃ based Ni,Ce catalyst (C6).

FIG. 7 comprises FIGS. 7a and 7b and refers to graphs that show the results of the catalytic performance tests for the CO to C6 catalysts at steam/carbon (S/C) ratio=0.3. FIG. 7a shows specific activity normalized to per gram Nickel and FIG. 7b shows comparison of CH₄ conversions against thermodynamic limit conversion (Brown dash-dot line).

FIG. 8a shows graph of thermogravimetric analysis-differential thermal analysis (TGA-DTA) profiles of spent C₁ catalyst from SMR reactions at S/C=0.3 and nitrogen as diluent. FIG. 8b shows graph of thermogravimetric analysis-differential thermal analysis (TGA-DTA) profiles of spent C2 catalyst from SMR reactions at S/C=0.3 and nitrogen as diluent. FIG. 8c shows graph of thermogravimetric analysis-differential thermal analysis (TGA-DTA) profiles of spent C3 catalyst from SMR reactions at S/C=0.3 and nitrogen as diluent. FIG. 8d shows graph of thermogravimetric analysis-differential thermal analysis (TGA-DTA) profiles of spent C4 catalyst from SMR reactions at S/C=0.3 and nitrogen as diluent. FIG. 8e shows graph of thermogravimetric analysis-differential thermal analysis (TGA-DTA) profiles of spent C5 catalyst from SMR reactions at S/C=0.3 and nitrogen as diluent. FIG. 8f shows graph of thermogravimetric analysis-differential thermal analysis (TGA-DTA) profiles of spent C6 catalyst from SMR reactions at S/C=0.3 and nitrogen as diluent

FIG. 9 comprises FIGS. 9a to 9c and refers to graphs showing the outcomes of the performance tests on undiluted SMR at S/C=0.3. FIG. 9a shows CH₄ conversions for CO and C4 pelletized catalysts. FIG. 9b shows CH₄ conversions for CO pelletized catalyst. FIG. 9c shows CH₄ conversions for C4 pelletized catalyst C4 catalysts.

### EXAMPLES

Non-limiting examples of the invention will be further described in greater detail by reference to specific examples, which should not be construed as in any way limiting the scope of the invention.

### Example 1: Preparation of Catalysts

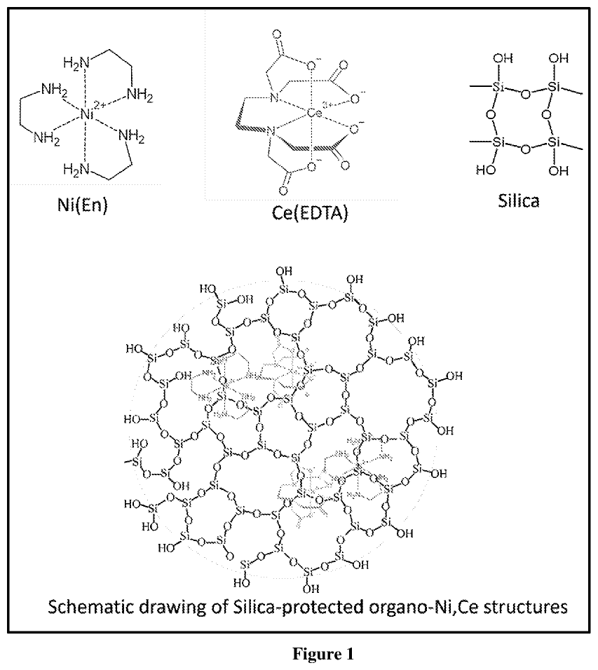

A catalyst with high coke resistance and activity was prepared using a silica protected Nickel (and Cerium) metal complex solution. The synthesis was facile and easily scaled up due to its one-pot methodology. Subsequently, a series of different supports (e.g., SiO₂—Al₂O₃—a typical catalyst support, and clays-a 3D printing viable material) were used to demonstrate versatility, where the metal complex-inorganic material hybrid was shown to be dispersed effectively. Importantly, a stable metal complex-inorganic material hybrid structure was prepared to disperse active metal homogeneously within a silica matrix in which silica was exploited to immobilize these metal complexes electrostatically and to protect the active metal against sintering and coking (FIG. 1). Herein, a total of 6 catalysts (denoted C₁ to C6) were prepared and proven to yield better carbon-resistance and activity for low steam to carbon steam methane reforming against a commercial Nickel-based Catalyst (denoted CO). Metal loadings were quantified in Table 1.

TABLE 1
Metal Loadings of Novel Catalysts and Commercial Catalyst

| | Ni* | Ce* | |
|---|---|---|---|
| Catalyst | (wt %) | (wt %) | Remarks |
| C0 | 11.8175 | — | Commercial Nickel-based Catalyst |
| C1 | 4.605 | — | Impregnated with 1x S0\hat{ } on Clay support |
| C2 | 0.41775 | — | Impregnated with 1x S0\hat{ } on SiO₂—Al₂O₃ support |
| C3 | 0.37175 | 1.70575 | Impregnated with 1x S1\hat{ } on SiO₂—Al₂O₃ support |
| C4 | 0.62675 | 1.43025 | Impregnated with 1x S2\hat{ } on SiO₂—Al₂O₃ support |
| C5 | 4.355 | 6.375 | Impregnated with 7x S2\hat{ } on 10% Ni/SiO₂—Al₂O₃ support |
| C6 | 2.92 | 7.1225 | Impregnated with 10x S2\hat{ } on SiO₂—Al₂O₃ support |
| C7 | 6.496 | — | Ni impregnated on SiO₂—Al₂O₃ support; non-silica protect |

*Metal loadings were determined using ICP-OES
\hat{ }S0-S1 denotes different Silica-protected metal-complex solutions detailed in the materials and methods section.

### Pretreatment of Silica-Alumina Support

Prior to use, an amorphous silica-alumina support (obtained from Sigma-Aldrich, St. Louis, Missouri, USA) was treated at 1000° C. for 20 hours (with 10 hours ramping. 1.6° C./min ramp) in a tube furnace under ambient pressure. The support was denoted SiO₂—Al₂O₃.

Preparation of 10% Ni/SiO₂—Al₂O₃

2.477 g Ni(NO₃)₂·6H₂O (98%) (obtained from Sigma-Aldrich, St. Louis, Missouri, USA) was dissolved in 10 mL ethanol (99.5%) and was used for the impregnation on 4.5 g SiO₂—Al₂O₃.

### Preparation of Silica Protected Nickel Complex Solution

7.6 g Tetrapropylammonium hydroxide solution (40% aq.), 3.6 g distilled water, and 8.8 g tetraethylorthosilicate (98%) (obtained from Sigma-Aldrich, St. Louis, Missouri, USA) were mixed under stirring at room temperature for 4 hours in a closed bottle. The initial clear silica solution consisted of a molar composition of (TPA) 20:SiO₂: H₂O:EtOH of 4.5:25:289:100. Then, 5 g of a Ni(NH₂CH₂CH₂NH₂)₃ solution (obtained from Sigma-Aldrich, St. Louis, Missouri, USA) which contained 13 wt % Ni(NO₃)₂·6H₂O and (NH₂CH₂CH₂NH₂)₃/H₂O at a weight ratio of 0.12:1 was added to 20 g of the silica solution. To form the Ni(NH₂CH₂CH₂NH₂)₃ solution, 1.8 g NH₂CH₂CH₂NH₂ (99.5%) and 2.5 g Ni(NO₃)₂·6H₂O (98%), were mixed in 15 mL of distilled water. The ratio between Ni and NH₂CH₂CH₂NH₂ was 1:3.6 by weight.

The mixture was continuously stirred at room temperature for 30 minutes to obtain a clear violet solution. The Ni(NH₂CH₂CH₂NH₂)₃ and tetraethylorthosilicate was mixed at a ratio of 1:8.6 by weight, and the ratio between Ni(NH₂CH₂CH₂NH₂)₃ and SiO₂ in the resultant product was 1:2.5 by weight. The solution was transferred into a closed sample bottle and kept in the fridge overnight. The sample was denoted SO.

### Preparation of Silica Protected Nickel, Cerium Complex Solution

7.6 g Tetrapropylammonium hydroxide solution (40% aq.), 3.6 g distilled water, and 8.8 g tetraethylorthosilicate (98%) (obtained from Sigma-Aldrich, St. Louis, Missouri, USA) were mixed under stirring at room temperature for 4 hours in a closed bottle. The initial clear solution consisted of a molar composition of (TPA) 20:SiO₂: H₂O:EtOH of 4.5:25:289:100. Then, 5 g or 10 g of a Ni(NH₂CH₂CH₂NH₂)₃ (obtained from Sigma-Aldrich, St. Louis, Missouri, USA) solution which contained 13 wt % Ni(NO₃) 2·6H₂O and (NH₂CH₂CH₂NH₂)₃/H₂O at a weight ratio of 0.12:1 were added to 20 g of the silica solution. To form the Ni(NH₂CH₂CH₂NH₂)₃ solution, 1.8 g NH₂CH₂CH₂NH₂ (99.5%) and 2.5 g Ni(NO₃)₂·6H₂O (98%), were mixed in 15 mL of distilled water. The ratio between Ni and NH₂CH₂CH₂NH₂ was 1:3.6 by weight. The mixture was continuously stirred at room temperature for 30 minutes to obtain a clear violet solution. 0.6 g of Ce(EDTA) solution which contained 6 wt % of Ce(NO₃) 3.6H₂O and Na₂EDTA.2H₂O/H₂O at a weight ratio of 0.135:1 was then added. To form the Ce(EDTA) solution, 0.675 g Na₂EDTA.2H₂O and 0.36 g Cc (NO₃) 3·6H₂O (obtained from Sigma-Aldrich, St. Louis, Missouri, USA) were mixed in 5 mL of distilled water. The ratio between Ce and Na₂EDTA.2H₂O was 1:5.8 by weight.

The obtained dark violet clear solution was transferred into a closed sample bottle and kept in the fridge overnight. The Ni(NH₂CH₂CH₂NH₂)₃ and tetraethylorthosilicate (obtained from Sigma-Aldrich, St. Louis, Missouri, USA) was mixed at a ratio of 1/8.6 by weight, and the ratio between Ni(NH₂CH₂CH₂NH₂)₃ and SiO₂ in the resultant product was 1/2.5 by weight. The Ce(EDTA) and tetraethylorthosilicate was mixed at a ratio of 1/247.7 by weight, and the ratio between Ce(EDTA) and SiO₂ in the resultant product was 1/71.15 by weight. The sample made with 5 g Ni(NH₂CH₂CH₂NH₂)₃ solution was denoted S1 while the sample made with 10 g Ni(NH₂CH₂CH₂NH₂)₃ solution was denoted S2.

### Preparation of C₁ Catalyst

1 g SO was impregnated in 50 mg halloysite clay (obtained from Sigma-Aldrich, St. Louis, Missouri, USA) with 7 mg of hydroxypropyl methyl cellulose (obtained from Sigma-Aldrich, St. Louis, Missouri, USA) and the mixture was dried under vacuum. The dried powder was calcined at 650° C. for 2 hours (100° C./h ramp) and sieved (40-60 mesh). The sample was denoted C₁.

### Preparation of C2 Catalyst

1 g SO was impregnated in 1 g SiO₂—Al₂O₃ (obtained from Sigma-Aldrich, St. Louis, Missouri, USA) and the mixture was dried under vacuum. The dried powder was calcined at 650° C. for 2 hours (100° C./h ramp) and sieved (40-60 mesh). The sample was denoted C2.

### Preparation of C3 Catalyst

1 g S1 was impregnated in 1 g SiO₂—Al₂O₃ and the mixture was dried under vacuum. The dried powder was calcined at 650° C. for 2 hours (100° C./h ramp) and sieved (40-60 mesh). The sample was denoted C3.

### Preparation of C4 Catalyst

1 g S2 was impregnated to 1 g SiO₂—Al₂O₃ and the mixture was dried under vacuum. The dried powder was calcined at 650° C. for 2 hours (100° C./h ramp) and sieved (40-60 mesh). The sample was denoted as C4.

### Preparation of C5 Catalyst

1 g S2 was impregnated in 1 g 10% Ni/SiO₂—Al₂O₃ and the mixture was dried under vacuum. The same impregnation procedure was repeated for 6 times. The overall composition comprised of 7 g solution and 1 g support. The dried powder was calcined at 650° C. for 2 hours (100° C./h ramp) and sieved (40-60 mesh). The sample was denoted C5.

### Preparation of C6 Catalyst

1 g S2 was impregnated in 1 g SiO₂—Al₂O₃ and the mixture was dried under vacuum. The same impregnation procedure was repeated for 9 times. The overall composition is 10 g solution and 1 g support. The dried powder was calcined at 650° C. for 2 hours (100° C./h ramp) and sieved (40-60 mesh). The sample was denoted C6.

### Preparation of C7 Catalyst

1.26 g Ni(NO₃) 2. 6H₂O (98%) was dissolved in 10 mL Ethanol and was used for the impregnation in 4.75 g SiO₂—Al₂O₃. The dried powder was calcined at 650° C. for 2 hours (100° C./h ramp). The sample was denoted C7.

### Example 2: Characterization Data of Catalysts

### XRD Measurement

A typical catalyst powder was scanned over a 20 range of 10-80° (ramp rate of 2°/min) in a Shimadzu XRD-6000 X-ray Diffractometer under the conditions of 1° divergence slit, 1° scattering slit and 0.3 mm receiving slit, Cu Kα X-ray source (beam voltage 40 kV and current 30 mA).

The catalysts prepared maintained an amorphous character, and X-ray

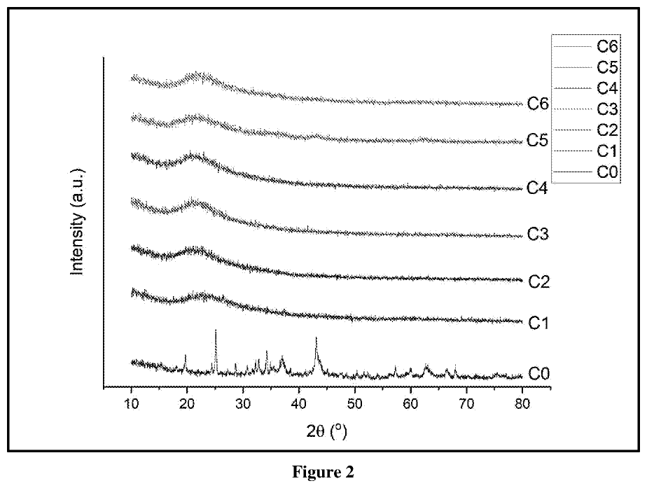

Diffraction (XRD) analysis confirmed the lack of well-defined peaks which indicates the absence of crystallites (FIG. 2). A broad peak from 20° to 30° denoted presence of an amorphous silica character. The diffraction peaks of the commercially obtained CO catalyst (20=44.5°, 51.8°, and 76.4°, PDF- #NO. 04-0850) corresponded to the (111), (200), and (220) crystal faces of Ni. NiO crystal faces were also observed at 20-37.2° and 62.9° (PDF- #NO. 47-1049). The C5 XRD pattern showed much less intense NiO peaks at 20=37.2° and 62.9° and a Ni(111) peak at 2θ=44.5° which suggested a highly dispersed amorphous nature (and small crystallite sizes) of nickel species on the C5 catalysts. Nickel faces in the other catalysts (C₁ to C₄ and C6) were not observable, due to low nickel loading (Table 1), small particle size and their highly dispersed amorphous nature.

### Catalytic Performance Tests

50 mg of catalysts was loaded into a quartz tube (O.D. =9 mm, I.D. =7 mm) sandwiched between quartz wool before fixing the quartz tube in a heating furnace. A Gasboard 3100 syngas analyzer was used to analyze product gas in the reaction. A liquid pump with heating belt (set at 250° C.) was used to supply steam, and a water trap with a chiller (set at 2° C.) was affixed before the syngas analyzer.

### Thermodynamic Analysis for Low Steam-Carbon Ratio SMR

Thermodynamic equilibrium of S/C=0.3 SMR at any given temperature at atmospheric pressure was calculated by minimizing Gibbs free energy of a multicomponent system. The total Gibbs free energy was the summation of all chemical potential of the species (i.e., methane, water, carbon monoxide, hydrogen, and carbon dioxide). Peng-Robinson Equation of State was chosen to estimate the fugacity coefficient estimations for non-polar systems. Thermodynamic equilibrium calculations were performed on Aspen Plus V12.1 using RGibbs reactor.

### Technoeconomic Analysis for Varying Steam-Carbon Ratio SMR

Aspen HYSYS V12.1 was used to evaluate the effect of steam to carbon ratio (S/C) and reaction temperature on SMR performance (i.e., methane conversion, CO₂ production (from reverse water gas shift and burning of natural gas to supply heat) and energy efficiency (kg H₂ produced per kg of CH₄ used in natural gas heating). Peng Robison equation of state was used as the fluid package in the simulation. A complete combustion of natural gas supplied at 3 bar and 30° C. (90% v/v CH₄, 5% v/v N₂ and 5% v/v CO₂) was assumed for supplying heat to a reactor. The amount of natural gas required was automatically adjusted and determined to supply enough heat energy for maintaining an isothermal reaction. The reaction was assumed to be operating at thermodynamic limit using a Gibbs reactor with a specified reaction equilibrium (i.e., steam methane reforming and water gas shift reactions). A series of varying S/C ratio (from 0.3 to 5) and reaction temperature (500° C. to 1000° C.) case studies were ran on Aspen HYSYS V12.1 and evaluated using Python script with a surf plot.

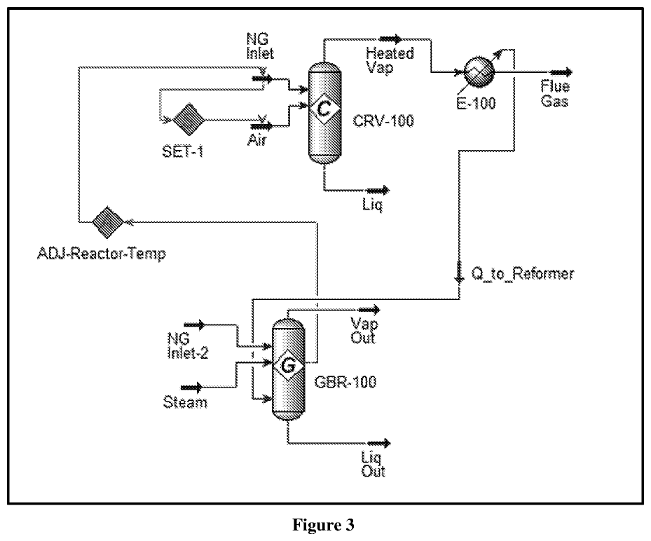

Simulation with Aspen HYSYS V12 of steam methane reforming process with typical natural gas feed (i.e., 90% v/v CH₄ with 5% v/v CO₂ and 5% v/v N₂) was studied (FIG. 3). Considering heating of reactor to be from the exothermic reaction between natural gas feed and air, independent variables of S/C ratio (from 0.3 to 5) and reaction temperature (from 500° C. to 1000° C.) were varied to investigate their combined effect on the steam methane reforming process. A Gibbs reactor was used to evaluate steam methane reforming performance at thermal dynamic equilibrium without limiting catalyst performance.

### H₂-TPR Measurement

50 mg of catalyst was used in each analysis in a Thermo Scientific TPDRO-1100 series equipment. H₂-TPR profile was obtained with 30 mL/min 5 vol % H₂ (balance in N₂) and ramping of 10° C./min from room temperature to 900° C.

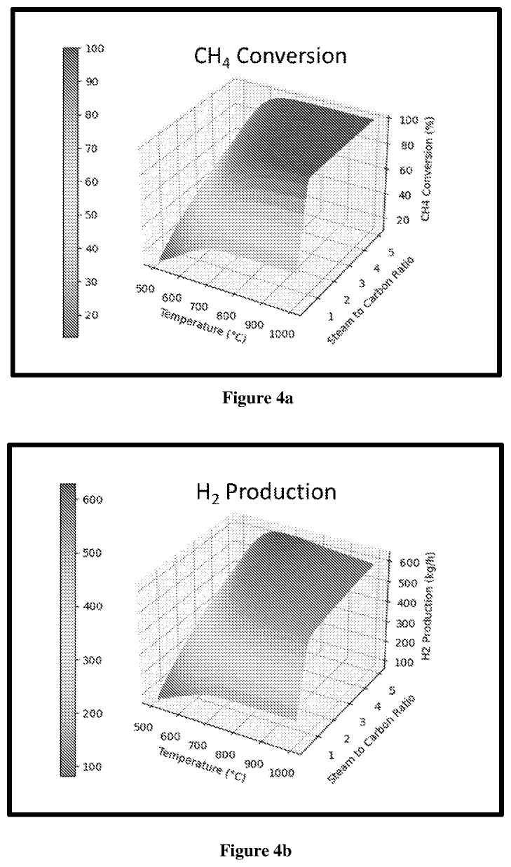

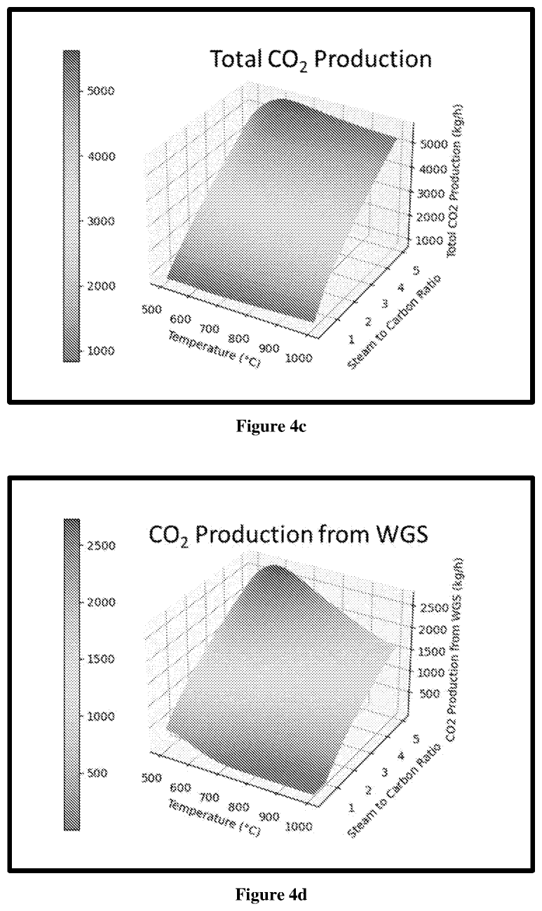

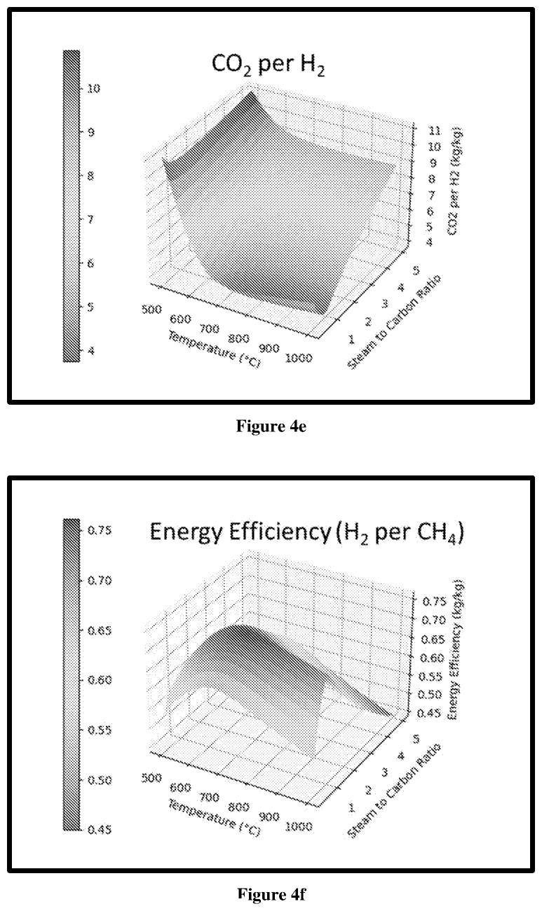

While thermodynamics dictate that higher operating temperature and S/C ratio will result in higher CH₄ conversion (FIG. 4a) and hence higher H₂ production (FIG. 4b), the amount of CO₂ produced both from the competing side reaction (i.e., water gas shift (WGS) reaction; H₂O+CO⇄CO₂+H₂) and natural gas oxidation for thermal heating per H₂ produced (henceforth denote as ‘Total CO₂ Production’) generally decreases with decreasing S/C ratio at the same operating temperature (FIG. 4e). At low S/C ratio, an optimal temperature between 600 to 750° C. gives the lowest amount of CO₂ per kg of H₂ production. Differential changes in total CO₂ production are more significant with a change in S/C ratio in comparison with changing operating temperature (FIG. 4c), and higher S/C ratio will result in more CO₂ produced in the steam methane reforming process. CO₂ production from only WGS is illustrated in FIG. 4d, where the relationship between CO₂ production from WGS and temperature or S/C ratio is similar to that of total CO₂ production (i.e., comparing FIGS. 4c and 4d). Importantly, low S/C ratio is beneficial for achieving low carbon steam methane reforming process. A performance variable, energy efficiency, defined as the amount of H₂ produced per kg of CH₄ used in natural gas heating is developed and illustrated in FIG. 4f. A high energy efficiency (i.e., more H₂ produced per heating unit; CH₄) is achieved at between 600° C. and 750° C. Subsequently, low-carbon steam methane reforming tests at the lowest S/C ratio (i.e., 0.3) and at 600° C. which are extremely harsh conditions that promote coke formation, were tested for the supported amorphous metal complex-inorganic material hybrid catalysts.

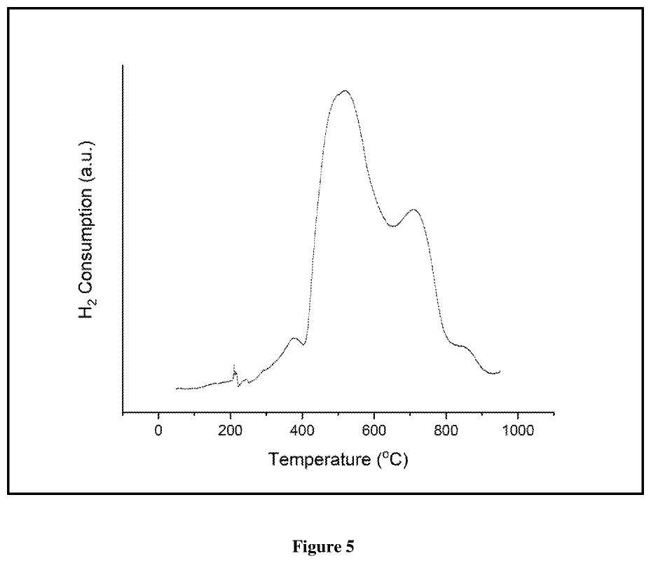

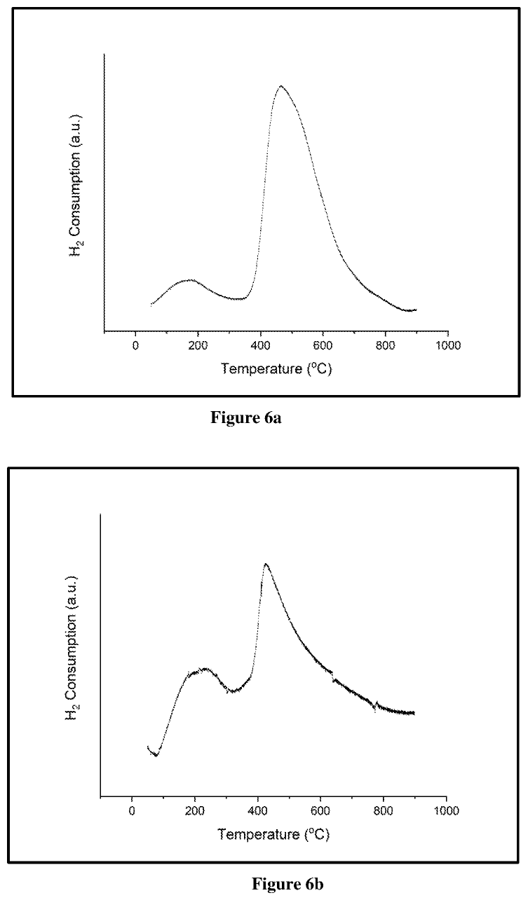

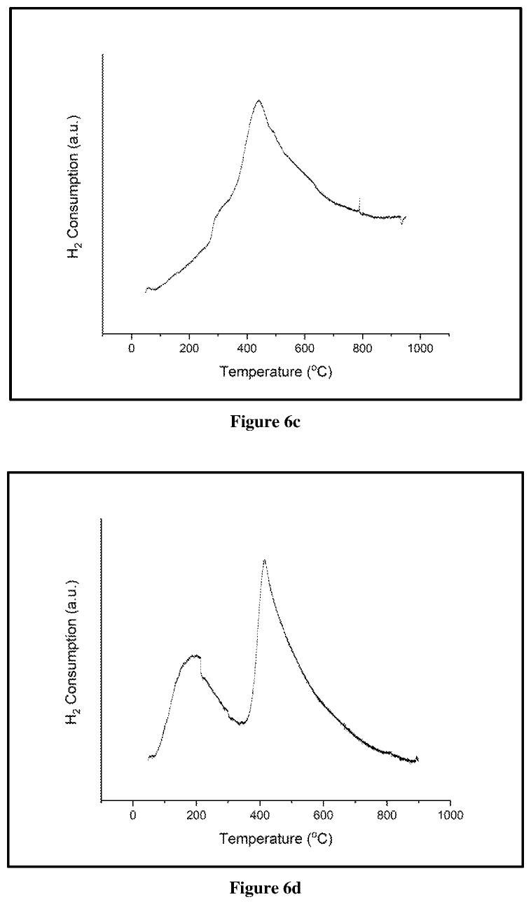

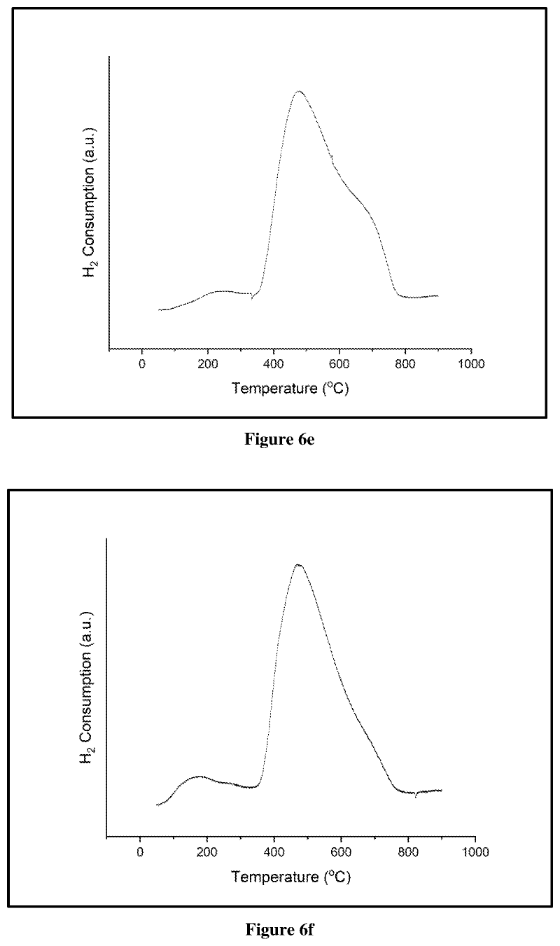

The catalysts were first reduced at 800° C. for 1 hour (10° C./min ramp rate) for CO catalyst and at 600° C. for 1 hour (10° C./min ramp rate) for C₁ to C₆ catalysts according to the H₂-temperature programmed reduction (H₂-TPR) profiles (FIG. 5 and FIG. 6).

### TGA-DTA Measurement

TGA-DTA was used to investigate coking in spent catalyst. Typically, about 7 mg of spent catalyst was used for the analysis in a Shimadzu DTG-60 equipment. Simultaneous heat flow and weight measurements were performed from room temperature to 950° C. with a ramp rate of 10° C./min under air atmosphere.

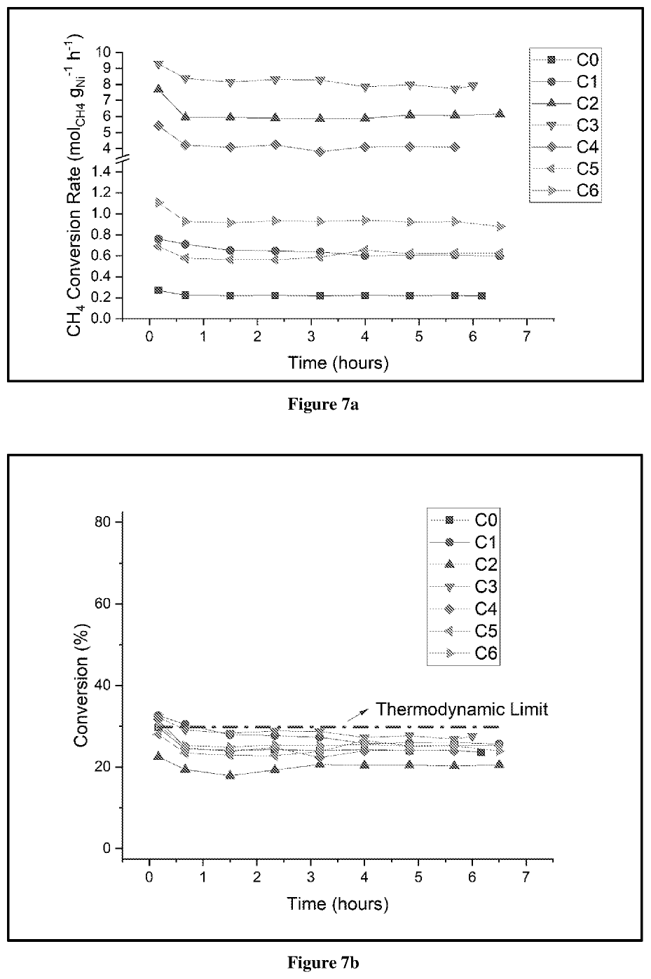

Each catalyst (CO to C6) was pelletized (40-60 mesh) prior to a reaction test. At S/C=0.3, specific activities of supported amorphous metal complex-inorganic material hybrid catalysts were constantly superior over the commercial catalyst (C0) (FIG. 7a), thereby showing that the disclosed method in functionalizing active metals (nickel) onto a catalyst support via silica-protection provided significant improvement in catalyzing low S/C SMR reactions while providing versatility in tuning support materials and active metal compositions.

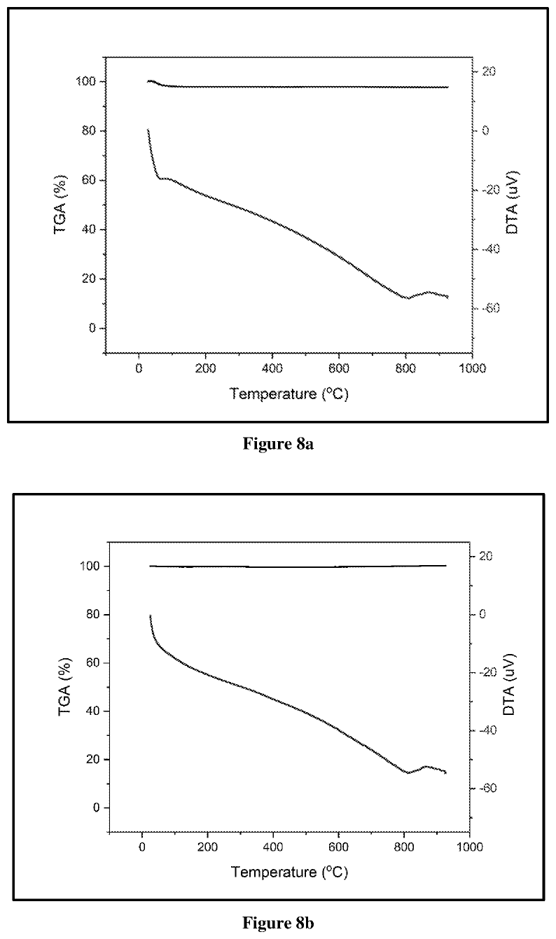

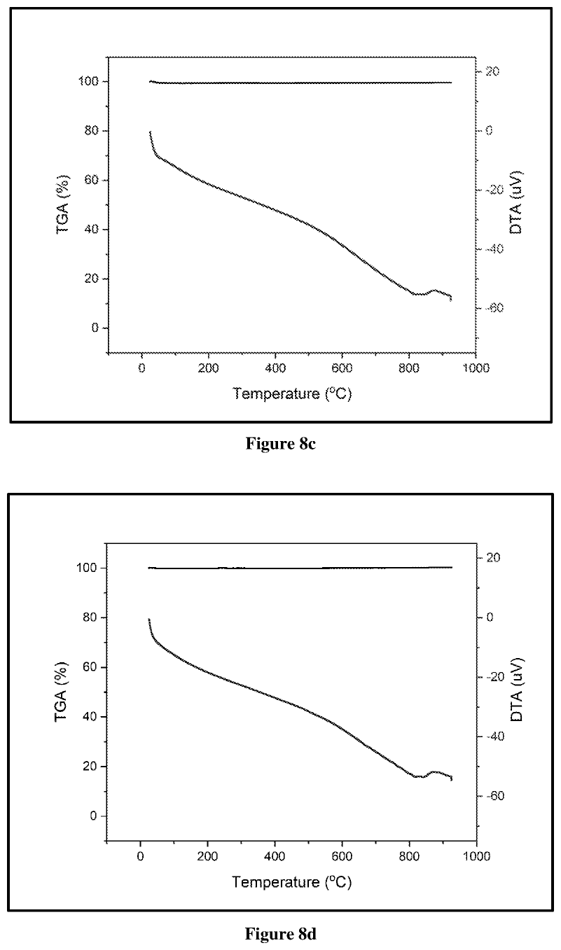

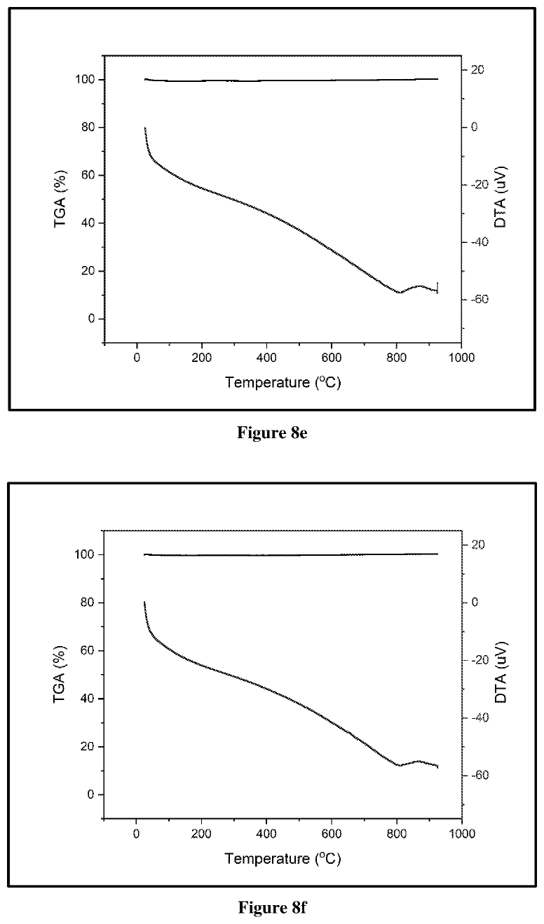

FIG. 7b shows that the supported amorphous metal complex-inorganic material hybrid catalysts can achieve close to thermodynamic limit conversions at a S/C=0.3 SMR process. Even despite the harsh low steam conditions that promote carbon formation, thermogravimetric analysis-differential thermal analysis (TGA-DTA) experiment on spent C₁ to C₆ catalysts showed negligible carbon formation (FIG. 8).

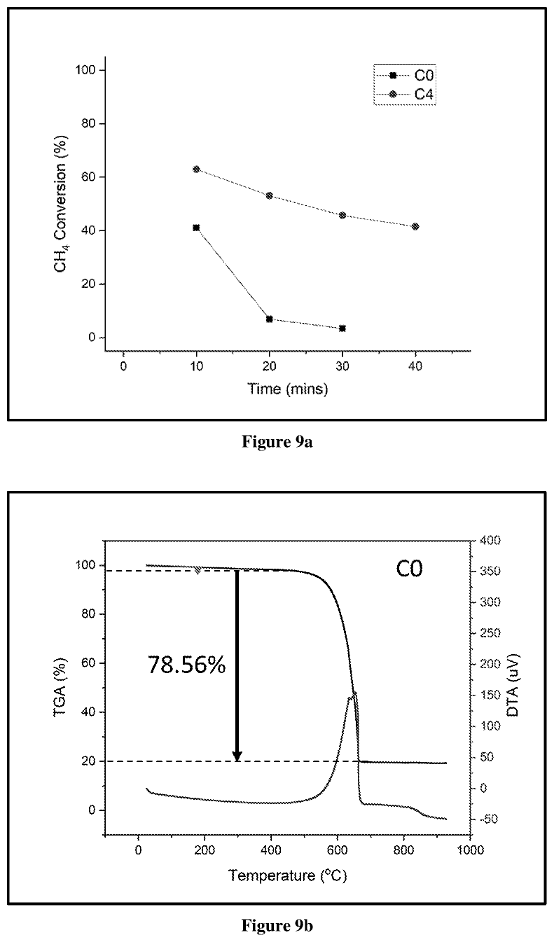

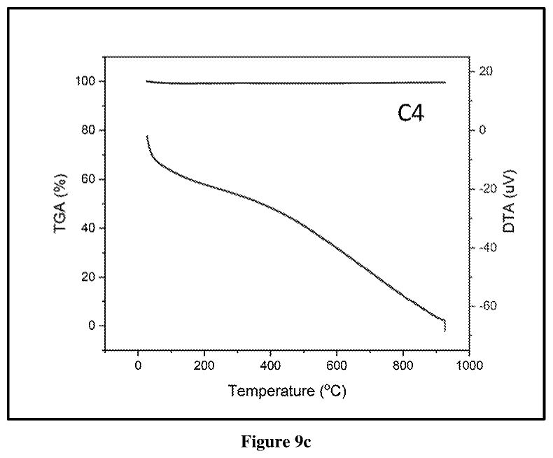

Undiluted (i.e., pure feed of methane and steam) SMR at S/C=0.3 was tested for a selected catalyst (C4) against the commercially obtained catalyst CO(FIG. 9a). The CO catalyst deactivated within 30 minutes with significant coking (˜ 78% carbon, FIG. 9b), meanwhile at the same condition, the C4 catalyst showed superior anti-coking ability

(FIG. 9c) while continuing to maintain high reaction activity.

### INDUSTRIAL APPLICABILITY

The disclosed catalyst composition may be used as a catalyst for Steam Methane Reforming (SMR) for the production of hydrogen and syngas from natural gas. This is applicable to industries such as energy, electrical and transportation, where the catalyst composition can be used as a highly active catalyst in low-carbon steam methane reforming.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A catalyst composition comprising a first metal complex, and optionally a second metal complex, dispersed throughout a matrix of an inorganic material.

2. The catalyst composition according to claim 1, wherein the first metal complex and the second metal complex is the same or different.

3. The catalyst composition according to claim 1- or 2, wherein the first metal complex and optional second metal complex independently comprise a catalyst metal and a ligand.

4. The catalyst composition according to claim 3, wherein the catalyst metal is selected from the group consisting of Ca, Mg, La, Ni, Pt, Co, Mo, Zr, Sr, Ce, Fe, Zn and any mixture thereof.

5. The catalyst composition according to claim 3, wherein the ligand is selected from the group consisting of ammonia, ethylamine, diethylamine, triethylamine, pyrrolidine, pyrrole, imidazolidine, pyrazolidine, imidazole, pyrazole, oxazolidine, isoxazolidine, oxazole, isoxazole, triazole, furazan, oxadiazole, dioxazole, tretrazole, piperidine, pyridine, diazinane, diazine, morpholine, oxazine, ethylene diamine (en), ethylene triamine, ethylenediaminetetraacetic acid (EDTA), ethyleneglycoltetraacetic acid, ethylendiaminedipropionic acid, hexamethylenediaminetetraacetic acid, dipicolinic acid, diethylenetriaminepentaacetic acid, nitrilotriacetic acid in their ionic and neutral form and any mixture thereof.

6. The catalyst composition according to claim 1, wherein the inorganic material comprises a compound selected from the group consisting of silicon, a silicon-containing compound, a metallosilicate, a heterometallosilicate, a metal oxide or a combination thereof as the main component.

7. The catalyst composition according to claim 1, wherein the ratio of the first metal complex and second metal complex, when present, to the inorganic material in the matrix is in the range of 1:1 to 1:80 by weight.

8. The catalyst composition according to claim 1, wherein the catalyst composition is in the form of particles with diameters in the range of 1 nm to 20 nm.

9. The catalyst composition according to any one of claim 1, wherein the catalyst composition is impregnated in a support material.

10. The catalyst composition according to claim 9, wherein;
a) the support material is selected from the group consisting of silica, alumina, silica-alumina, aluminosilicate mineral, aluminium silicate, titanium silicate, clay, halloysite clay, metal alloy, montmorillonite clay, zeolite, porous glass, support metal oxide, support semi-metal oxide, molecular sieve, silica gel and any mixture thereof; and/or
b) the support material is impregnated with the catalyst composition at a ratio in the range of 2:1 to 1:15 by weight.

11. (canceled)

12. The catalyst composition according to claim 1, wherein the first metal complex is [Ni(en)₃] (NO₃)₂ and the second metal complex, when present, is [Ce(EDTA)] (NO₃)₃.

13. A method for preparing a catalyst composition comprising a first metal complex, and optionally a second metal complex, dispersed throughout a matrix of an inorganic material, comprising the steps of:
(a) providing a solution of the first metal complex and optionally a solution of the second metal complex;
(b) providing a solution of the inorganic material; and
(c) mixing the solution of the first metal complex and optionally the solution of the second metal complex with the solution of the inorganic material, to form a dispersion of the first metal complex, and optionally the second metal complex, throughout the matrix of the inorganic material and thereby the catalyst composition.

14. The method according to claim 13, wherein the providing step (a) comprises the step of mixing a first catalyst metal salt with a first ligand in a first solvent to form the first metal complex, wherein the first catalyst metal salt comprises a first catalyst metal cation of a first catalyst metal and a first counteranion, and
where the second metal complex is present, the step of mixing a second catalyst metal salt with a second ligand in a second solvent to form the second metal complex, wherein the second catalyst metal salt comprises a second catalyst metal cation of a second catalyst metal and a second counteranion.

15. The method according to claim 14, wherein the first catalyst metal and the first ligand is mixed at a ratio in the range of 1:2 to 1:7 by weight and wherein the second catalyst metal and the second ligand, when present, is mixed at a ratio in the range of 1:2 to 1:7 by weight.

16. The method according to claim 13, wherein the providing step (b) comprises the steps of (b1) mixing an inorganic material precursor with a third solvent, wherein the inorganic material precursor is selected from the group consisting of silane, orthosilicate, tetramethyl orthosilicate, tetraethyl orthosilicate, aluminium chloride, aluminium nitrate, aluminium sulphate, tetrabutylortho titane, tetraethyl titane, tetrapropylortho titane, Na₂HAsO₄·7H₂O, H₃BO₃, BeSO₄·4H₂O, Cr(NO₃)₃·9H₂O, In(NO₃)₃·xH₂O, Ti[OCH(CH₃)₂]₄, Zr(NO₃)₄, Fe(NO₃)₃·9H₂O, Co(NO₃)₂·6H₂O, NaVO₃, Ga(NO₃)₃·xH₂O, Ge(OCH(CH₃)₂)₄, KSb(OH)₆, Na₂SnO₃·3H₂O, Na₂MoO₄, Mg(NO₃)₂·6H₂O, Na₂WO₄·2H₂O and any mixture thereof, wherein the third solvent is water or an aqueous solution; and
(b2) hydrolyzing the inorganic material precursor with a base, wherein the base is selected from the group consisting of tetrapropylammonium hydroxide, tetramethylammonium hydroxide, tetraethylammonium hydroxide, tetrabutylammonium hydroxide, hexapropyl-1,6-hexanediammonium, N,N,N-trimethyl-1-adamantanammonium hydroxide, and any mixture thereof.

17. (canceled)

18. The method according to claim 13, wherein the mixing step (c) is undertaken at least one of:
(i) a temperature in the range of 20° C. to 30° C.;
(ii) an ambient pressure in the range of 90 kPa to 110 kPa;
(iii) a duration in the range of 15 minutes to 2 hours;
(iv) a pH in the range of 8 to 14; or
(v) all of (i) to (iv).

19. The method according to claim 13, wherein in the mixing step (c) the solution of the first metal complex and solution of the second metal complex, when present, to the solution of the inorganic material is present at a ratio in the range of 1:5 to 1:260 by weight.

20. The method according to claim 13, further comprising the steps of:
(d) impregnating a support material with the catalyst composition after mixing step (c) by mixing the catalyst composition with the support material, or contacting a solution of the catalyst composition with the support material;
(e) drying the catalyst composition after the mixing step (c) or the impregnated support material after the impregnating step (d); or
(f) calcining the catalyst composition after the mixing step (c), after the drying step (e) or the impregnated support material after the impregnating step (d).

21. A catalyst comprising a catalyst composition comprising a first metal complex, and optionally a second metal complex, dispersed throughout a matrix of an inorganic material,
a) a first metal complex, and optionally a second metal complex, dispersed throughout a matrix of an inorganic material; or
b) a first metal complex, and optionally a second metal complex, dispersed throughout a matrix of an inorganic material embedded in a support material.

22. (canceled)

23. (canceled)

24. A method for converting natural gas to syngas, the method comprising the step of contacting the catalyst composition according to claim 1 as a catalyst or the catalyst of claim 21 or 22, with natural gas.
